(19) United States
(12) Patent Application Publication
(10) Pub. No.: US 2002/0157030 A1
(43) Pub. Date: Oct. 24, 2002

(54) Power conservation in communication systems

(75) Inventors: Kenneth James Barker, Cary, NC (US); Hayden Clavie Cranford JR., Apex, NC (US); Charles Reeves Hoffman, Raleigh, NC (US); Jeffrey James Lynch, Apex, NC (US); Mark Edmund Scheuer, Wake Forest, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 09/839,179

(22) Filed: Apr. 19, 2001

(51) Int. Cl. G06F 1/26; G06F 1/32

(52) U.S. Cl. 713/320

(57) ABSTRACT

Components of an Ethernet communication system are placed in low power modes when such low power modes are feasible and permitted. The auto-negotiation next page feature of the Ethernet standard is utilized to exchange signals indicating that both ends of the system are capable of a low power mode. If capable and conditions for low system power usage permit, then the auto-negotiation feature is used to signal the eligibility of both ends of the system to enter a low power mode at which time the low power mode is activated. The system remains in the low power mode until data is to be transmitted.

### BACKGROUND OF THE INVENTION

1. Field of the Invention

This invention relates to saving power in ECP (Environmentally Conscious Product) design. The invention particularly relates to the use of the IEEE 802.3 standards based link auto-negotiation to effect power mode changes. More particularly, it relates to the employment of the next page facility of auto-negotiation to control the power level mode.

2. Description of the Related Art

In Ethernet LAN systems, a technique called Magic Packet is used to activate some powered-down devices. Ethernet products normally remain in a mode corresponding to the standard speeds in which the communications link was established. In a usual case, once the system has auto-negotiated to 100BaseTx (100 megabit per second speed) mode and transmitted data, the adapter, switch, router, et al. will remain in the 100BaseTx mode until some other system restart action is taken. The latter can be at initial power on (IPO) or when the physical layer device (PHY) at the other end of the cable switches to another mode of the Ethernet standard. From a performance or availability standpoint, this presents no problem.

From a power consumption perspective, however, it does present a problem, especially since the 100BaseTx continuously transmits an unscrambled idle data pattern. This causes a transceiver to consume power to transition the cable voltage at a rate which is determined by the data code and the scrambler. Also, the other system components such as the Media Access Control (MAC) and other Open System Interconnect (OSI) components typically to operate at full power. Although some power saving features can be used while the PHY is only in one of several speed modes, once the PHY logic and adapter have determined that the 100BaseTx mode is viable, the logic will remain in that mode until reset or a power down occurs. Once the system is powered up, it will negotiate to the highest available speed mode without regard to power consumption.

### BRIEF SUMMARY OF THE INVENTION

The invention enables low power modes by insuring that the data terminal equipment at both ends of the communication exchange system are capable and eligible to enter a low power mode. It employs a standard auto-negotiation procedure adapted to execute the low power process. In the auto-negotiation method of the invention, the adapter can be powered down as well as powered up.

In accordance with the invention, data terminal equipment devices at both ends of a communication system for exchanging data signal one another whether each is capable of a low power mode. If both devices are capable of a low power mode, then subsequently in response to conditions of low usage, the devices exchange signals indicating eligibility. If both devices are eligible for the low power mode, then both ends of the system enter a low power usage state and remain therein until signals are exchanged that permit data communication by resumption of normal power modes by both ends of the data exchange system.

### BRIEF DESCRIPTION OF THE DRAWING

The invention is described in detail by referring to the various figures which illustrate specific embodiments of the invention, and wherein like numerals refer to like elements.

FIG. 1 is a block diagram of a typical LAN system with the connective communication devices.

FIG. 2 is an illustration of an Organizational User Identifier tag code that complies with the IEEE 802.3 Standard.

FIG. 3 is a flowchart of a process according to the invention.

FIG. 4 is a flowchart of the LPM check of FIG. 3.

FIG. 5 is a block diagram of a typical hardware implementation of a media access control and a physical layer device such as found in an Ethernet LAN.

FIG. 6 is schematic representation of a Magic Packet Frame Structure.

### DETAILED DESCRIPTION OF THE INVENTION

Logic chips often have some power saving feature. For Complementary Metal Oxide types, the clock generator can be disabled since power is consumed only during switching. Some integrated circuits have a capability to selectively power down certain parts when not in use, others by slowing down the clock. The manner in which power saving functions is design dependent. Some chips can be powered down completely whereas others need to maintain some level of power so as to save state information. The power conservation features are not part of the invention which is directed to determining and controlling the activation of such features.

Ethernet Data Terminal Equipment (DTE) can be put into a low power mode state to conserve power consumption. The following description applies to Ethernet, the most popular LAN adapter. LAN (Local Area Networks) usually comprise large numbers of DTEs so it is especially important to be able to put unused or idle equipment in power saving states, sometimes referred to a putting them to sleep.

Many networks are considered ‘mission critical’ and need to be available 100% of the time. This does not mean that all the components must run at full power all the time even during periods of low usage or while not required.

In the following description, the abbreviations listed below are used. Most are part of the IEEE 802.3 Standard related to Local Area Networks and Ethernet systems. The invention is described as applied to a LAN but can be used in other multi-device systems having some form of auto-negotiation capability.

AUI—Attachment Unit Interface

DTE—Data Terminal Equipment

ECP—Environmental Conscious Product

GBS—Billion (Giga-) bits per second

GMII—Gigabit Media Independent Interface

IPO—Initial Power On

LAN—Local Area Network

LLC—Logical Link Control

LPM—Low Power Mode

MAC—Media Access Control

MAU—Medium Attachment Unit

MBS—Million (Mega-) bits per second

MDI—Media Dependent Interface

MIB—Management Information Base

MII—Media Independent Interface

OSI—Open System Interconnect

OUI—Organizationally Unique Identifier

PCS—Physical Coding Sublayer

PHY—Physical Layer Device

PLS—Physical Layer Signaling

PMA—Physical Medium Attachment

PMD—Physical Medium Dependent

PMD—Physical Media Dependent (sublayer of the Ethernet Physical Layer)

PMI—Physical Media Interface

Tx_PCS—interface lead to the PCS sublayer

10BaseT—an IEEE 802.3 physical layer specification for a 10 MBS local area network connection using two twisted-pair telephone wires.

100BaseTx—an IEEE 802.3 physical layer specification for a 100 MBS local area network connection using twisted pair wire.

Ethernet 10/100 MBS systems operate in more than one mode. The 10 MBS and 100 MBS systems are designed to operate compatibly through the use of auto-negotiation algorithms to determine in which mode the system is operating. In a 10 MBS only system, a data packet is transmitted followed by a series of idle pulses. Then a link pulse is transmitted every 8 to 24 milliseconds. In a 10/100 MBS system, fast link pulses are transmitted to determine whether the system should be changed to one of the other possible modes for faster data transmission, e.g., the 100BaseTx transmission speeds. The fast link pulses occur at a more rapid rate that the 10BaseT link pulses. The number and spacing of the fast link pulses indicate which of the Ethernet standards is being used. After a determination of the Ethernet standard in use and its implied transmission speed, the PHY switches to the appropriate mode of operation, usually the 10BaseT or 100BaseT.

The invention utilizes the capability of system intelligence, whether embodied in hardware or software, under the command of algorithms specifically designed to optimize power savings. If the system has power saving capabilities, the system will work at its highest speed until no packets are to be transmitted. If power saving criteria are met such as night or holidays or other low usage periods are met, then the system components are dropped back to the 10BaseT mode where it remains until auto-negotiation or data specifies that faster data is about to be received. The advantage of the procedure is that, whereas 100BaseTx (and some other Ethernet standards) are high power modes, 10BaseT requires a link pulse only every 24 milliseconds. This allows the PHY energy use to be on a low duty cycle and the other components of the systems to be put to sleep, e.g., put in a LPM. The algorithm, inter alia, checks whether to put both ends of the communication structure are compatible for entering LPMs and for restoring power when necessary.

The invention uses the IEEE 802.3 Standard-based link auto-negotiation procedure to ensure functional compatibility and to signal power mode changes. It has the advantage that it can occur at any time. The next page facility of auto-negotiation is employed to indicate that a DTE is LPM capable and whether it can be put in a LPM, i.e., eligible for the LPM.

Once both DTEs can be put in a LPM, their transmission circuits are turned off and their receive and auto-negotiation circuits remain powered, but can be put in the 10BaseT mode to conserve power.

In communications systems for coupling computers together to exchange data, certain devices must be powered for specific operations. In the Ethernet system, the physical layer receive logic, auto-negotiation, synchronizer, clock generator, PMD, and PMI must remain in a 2 powered-up state to begin the auto-negotiation process. Once begun, the PHY transmit, Tx_PCS, PMD, and PMI must be powered up to complete the process.

One arrangement requires that the PHY logic and the receive MAC State logic, Address Match, and State Register have full power in order to receive a Magic Packet. The latter only wakes a powered-down system since the adapter must be powered up to receive the Magic Packet. Using the auto-negotiation method according to the invention, the adapter can be in either the powered-up or the powered-down condition.

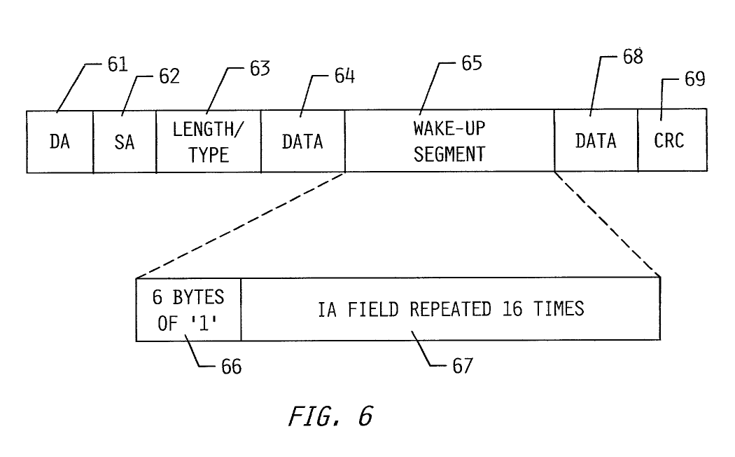

The Magic Packet requires that the receive PHY logic be active to receive the frame and the MAC logic must be active to decode the Magic Packet format. The structure of a Magic Packet is shown in FIG. 6. The destination address 61 segment comprises six bytes. The destination address of the Magic Packet frame can be either the adapter's individual address or a broadcast address.

The source address 62 uses six bytes. The data fields 64 and 68 can include from 46 to 1500 bytes. The specific length is denoted in a length/type field 63.

A CRC field 69 contains four bytes of a cyclic redundancy check for error control.

A Magic Packet (wake-up) segment 65 is shown expanded into a header 66 of six bytes (48 logical 1s) and the individual address field repeated 16 times.

The Magic Packet segment can be located anywhere within the payload data of the Magic Packet frame. Once a Magic Packet segment is detected, a Magic Packet output signal is asserted which will cause a host interrupt to be generated while it is asserted. When the system including an adapter with Magic Packet detection logic is powered down, it can be awakened (powered up) by the adapter when the adapter receives a Magic Packet so long as the adapter remains powered up. When the system ascertains that it can return to a sleep mode, it will do so until the adapter received a subsequent Magic Packet.

The Address Match logic is needed to match the Magic Packet contents with the MAC address. It is not always the case that the Address Match logic is located in the MAC, e.g., in those cases where the filtering is performed in the higher layers. It only supports wake-on-LAN so the adapters cannot be powered down or entered into a “sleep” mode.

On the other hand, with auto-negotiation the MAC can be in a powered-down condition while the auto-negotiation process occurs. The auto-negotiation technique permits the adapter to be in a powered-down state. Only the PHY receive logic must be powered up but can be in a 10BaseT lower power mode.

An example of the procedure starts with DTE IPO followed by an initial link. The auto-negotiation process exchanges signals indicating whether they are capable of LPM. This can be done, for example, via the OUI (explained in detail below) low order bit. Eligibility to go to the LPM is not signaled at this time.

After a time period or after data packets have been transmitted, one of the DTEs determines that it is eligible to go to a LPM. The reasons include a period of inactivity, operator intervention, low usage times, and the like. It then performs auto-negotiation again but this time it indicates it is LPM eligible. This is done, for example, using the next higher bit of the OUI as explained below. If the other DTE is not eligible for a LPM, both DTEs remain in a normal power mode. If the other DTE is also eligible, then it initiates another auto-negotiation exchange indicating it is LPM eligible. If the first DTE is still LPM eligible, then both DTEs perform a LPM transition.

When one of the DTEs is ready to transmit data, it initiates an auto-negotiation exchange indicating it is no longer LPM eligible. This causes both DTEs to resume a normal power mode.

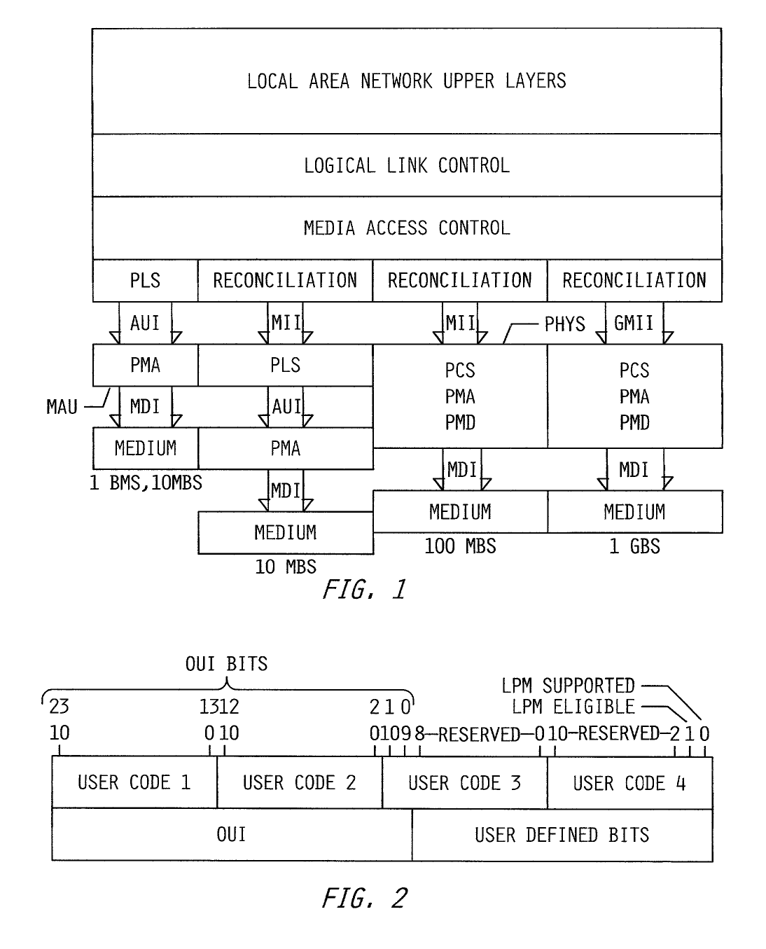

The auto-negotiation exchange comprises a base page plus optional next pages. One of the standard defined next pages is the OUI tagged message as defined in Clause 28C (Message Code #5) of the IEEE 802.3 Standard. The format is described in connection with FIG. 2 below.

FIG. 1 is included as background and shows the various devices in a LAN DTE. The upper layers and logical link control are coupled together via a number of physical layer devices, PHYs. The configurations can adapt to different speeds of communications. The key to system adaptability is the MAC. The invention is directed to conserving power by putting the MAC and higher layers into a LPM.

FIG. 2 is an illustration of an Organizational Unique Identifier. It is part of the IEEE 802.3 standard. It is preceded by a bit pattern of 0000 0000 0101. The remainder constitute four user code fields. The 24 bits, comprising the user code fields 1 and 2 plus the top two bits of the user code 3, identify the user and the remaining 20 bits are defined by the user. In FIG. 2, the least two significant bits, i.e., the low bit of user code 4 are utilized by the invention to communicate the LPM capabilities and conditions of the devices.

In the following description, references are made to the flowcharts depicting the sequence of operations performed by a computer system. The symbols used are standard flowchart symbols recommended by the American National Standards Institute and the International Standards Organization. In the explanation, an operation may be described as being performed by a particular block in the flowchart. This is to be interpreted as meaning that the operations referred to are performed by programming and executing a sequence of instructions that produces the result said to be performed by the described block. The actual instructions used depend on the particular system used to implement the invention. Different processors have different instruction sets but persons of ordinary skill in the art are familiar with the instruction sets with which they work and can implement the operations set forth in the blocks of the flowchart.

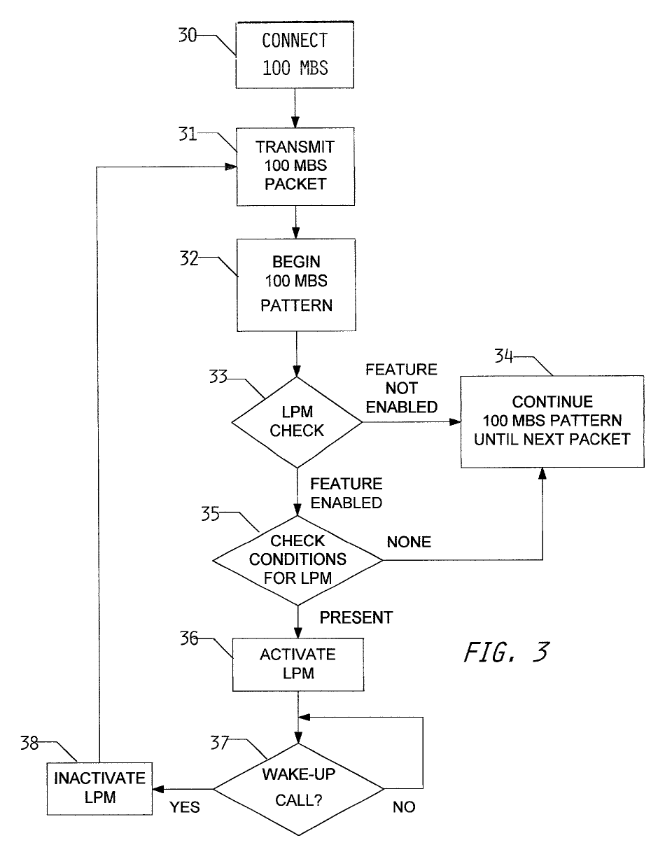

FIG. 3 is an illustrative flowchart of the invention. The procedure begins, for example, when an Ethernet 100 MBS connection is established shown by a process block 30. The message packet is transmitted by a process block 31, and then the 100 MBS idle pattern begins at a process block 32.

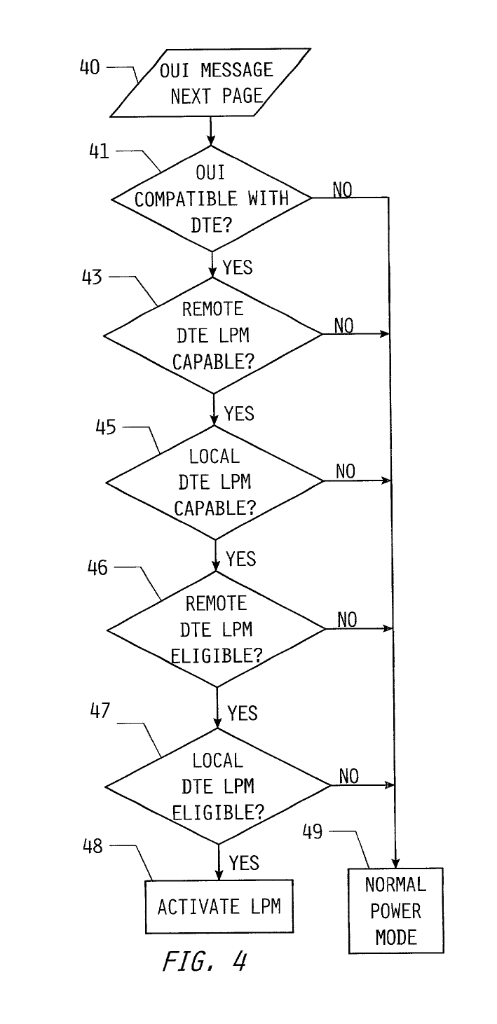

Next, a decision block 33 tests whether an LPM feature is enabled. The details of this test are shown in FIG. 4. If the feature is not enabled, i.e., not capable or not eligible, then the 100 MBS idle pattern continues as shown by a process block 34 until another packet is to be transmitted. No attempt is made to send commands to the rest of the system to attempt a power saving mode.

If the LPM feature is enabled, a test is made by a decision block 35 to determine whether valid conditions are met to permit the system to be switched to an LPM. Examples of conditions that would validate entering an LPM mode include night hours (not normal work hours), timeout (the system has not been used for a predetermined period of time), an operator-generated signal, or a low activity time (holidays and week ends). If the preprogrammed conditions are not present, then the 100 MBS (or exising) idle pattern continues until another data packet is to be transmitted as shown by the process block 34.

If the necessary conditions are present, then the LPM is activated as shown by a process block 36. In an Ethernet environment, this could cause switching to the 10BaseT mode and link pulses continue at the lower rate while the physical layer is in the LPM. Command signals are transmitted to the both ends of the system, e.g., the client and the server (or switch or router) ends. The upper communication layers enter an LPM as specified by their particular system program.

The PHY enters an LPM but continues to monitor the link pulses for the start of packet patterns. The PHY monitoring is shown as a decision block 37 which issues a wake-up call, i.e., restoration of full power mode, when it detects link pulses for starting packet patterns for 10BaseT, for 100BaseTx, or data patterns or for a specified pattern of fast link pulses indicating autonegotiation is preparing to restore full power for receiving 100BaseTx, 1000BaseT, or other system mode.

If no wake-up call is detected, the PHY (and other system components which may be in an LPM) continue in the LPM. If a wake-up call is detected, then the LPM is inactivated and corresponding command signals are transmitted to the client and server (or switch or router) ends. The upper communication layers are changed to their normal power levels and a receiving mode is restored. The PHY also has its normal full power restored and enters its normal data receive/send mode.

The process then resumes at the process block 31 for receiving or transmitting data.

FIG. 4 shows details of the LPM check shown in FIG. 3 as the decision block 33. An OUI message for autonegotiation of a next page is received by an input/output block 40. Then follows a number of tests to determine whether the coupled devices can be powered down to conserve power. The first test in a decision block 41 checks to determine whether the OUI is compatible with the DTE.

Each DTE's design dictates whether it can respond to OUI LPM information received from its link partner. If it is unable to respond, it will not declare its OUI LPM ability during the auto-negotiation process. If the DTE does not support the LPM, it will take the NO path from the decision block 41. Assuming the DTE supports LPM, the YES path is taken from the decision block 41. During the auto-negotiation process, the remote DTE will transmit its capabilities to its link partner so that both can perform the checks indicated by FIG. 4. The LPM will be performed only if both DTEs are able to perform the LPM function.

Next, the remote DTE is tested to ascertain whether it is low power capable. This is done using the 0 bit of user code 4 of an OUI as shown by a decision block 43. A decision block 45 checks whether the local DTE is LPM capable. Two more decision blocks 46 and 47 test the eligibility of the remote and local DTE, respectively, to determine whether they are eligible for the LPM.

If any of the tests fail, normal power is continued as shown in a process block 49. If all tests are successful, the LPM is activated as shown in a process block 48.

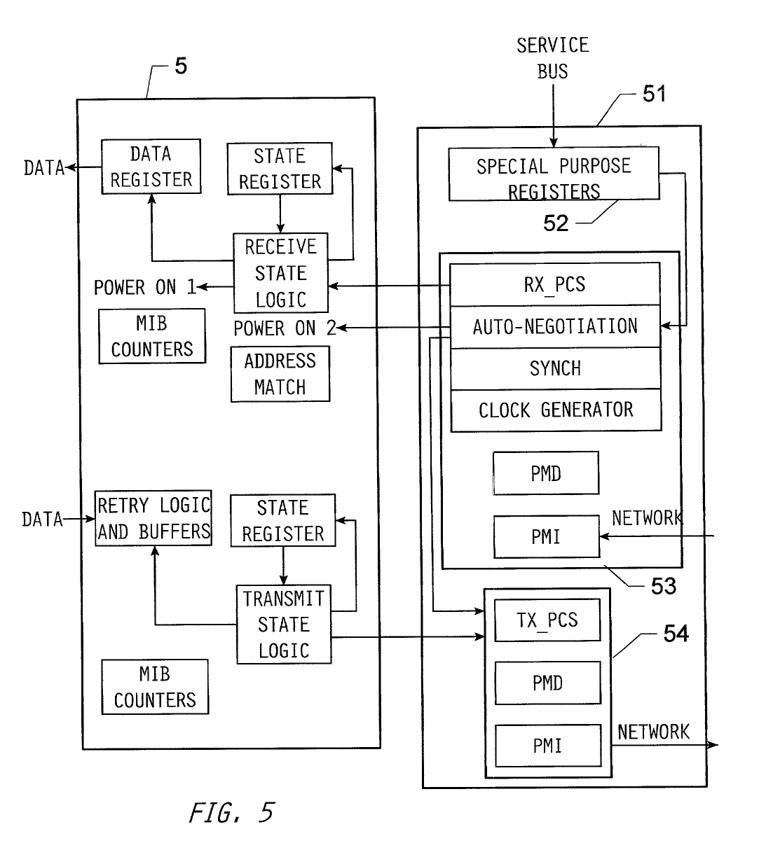

FIG. 5 is provided for reference and shows a typical hardware set-up of a MAC 5 and a PHY 51 for a 10/100 MBS Ethernet MAC and PHY. The functions of the various components are well known in the art and need not be explained in detail for an understanding of the invention. The special registers 52 include the auto-negotiation registers as well as other PHY registers. The components of the group 53 must remain powered up to begin the auto-negotiation process and those of the group 54 must be powered up to complete the process. The complete receive PHY logic and the receive MAC State Logic, Address Match, and State Register must remain powered up to receive a Magic Packet, which only wakes up a powered-down system. This is shown as the POWER ON 1 signal. The POWER ON 2 is the signal for powering up generated by the auto-Docket negotiation method according to the invention.

In a 1000 MBS Ethernet MAC and PHY, the special registers 52 and the logic group 53 (except for the PMD and PMI circuits) are located in the MAC.

While the invention has been particularly shown and described with reference to a preferred embodiment thereof, it will be understood by those skilled in the art that various changes and modifications in form and details may be made therein without departing from the spirit and scope of the invention according to the following claims.

What is claimed is:

1. A method of conserving power consumption in a communication system which includes components capable of selectively entering a low power mode and an auto-negotiation feature by exchanging messages indicative of a low power mode capability, using an auto-negotiation feature to interpret exchanged signals to verify that connected systems include the low power mode capability, and transmitting a signal that a communications session is completed to cause connected systems to enter the low power mode.

2. The method of claim 1 wherein said auto-negotiation feature is a next-page facility.

3. The method of claim 1 including a further step of employing the auto-negotiation feature further to verify that the connected systems are eligible to enter the low power mode.

4. In a system utilizing a data communication device having a plurality of data exchange modes, each of said modes operating at different speeds, one of which speeds consumes less power than another, protocol means for compatibly coupling said data communication device to another data communication device for exchanging data therebetween, and selection means in said data communication device for a data exchange mode having a higher speed than the others, a method for switching to a least power consuming speed which consumes when in an idle mode by exchanging data representative of said data communication devices ability to operate at the least power consuming speed, decoding via said protocol means said representative data, and changing to said least power consuming speed in response to another protocol signal.

5. In a local area network which includes Ethernet data terminal equipment capable of low power modes and employing auto-negotiation, a method for conserving power consumption during periods of low usage by using a next-page aspect of the auto-negotiation feature to communicate among terminal data equipment each equipment's capability to assume a low power mode, detecting periods of low network usage, verifying in response to detection of low network usage that each equipment is eligible to assume the low power mode by use of the auto-negotiation feature, and asserting signals to put each eligible equipment in a low power mode of operation.
